(19) United States
(12) Patent Application Publication
(10) Pub. No.: US 2006/0236721 A1
(43) Pub. Date: Oct. 26, 2006

(54) Method of manufacture for a compound eye

(75) Inventor: Jerome B. Franck, Fairfax, VA (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(73) Assignee: UNITED STATES OF AMERICA AS REPRESENTED BY THE DEPT OF THE ARMY

(21) Appl. No.: 11/110,992

(22) Filed: Apr. 20, 2005

(51) Int. Cl. C03C 19/00; C03B 29/00; C03B 23/00

(52) U.S. Cl. 65/61; 65/102; 65/65

(57) ABSTRACT

The invention is a method of manufacturing a compound eye (CE) by ablating a monolithic structure with a laser and then creating a mould from the monolithic structure and duplicating the mould. After one CE is constructed, then an inverse mask (mould) is created and the monolithic sphere, retaining its' registration, is covered in liquid plastic and placed into the mould and the exact replica is re-created. The advantage is low cost and rapid manufacture of the CE.

### GOVERNMENT INTEREST

The invention described herein may be manufactured, used, sold, imported, and/or licensed by or for the Government of the United States of America.

### FIELD OF THE INVENTION

The present invention generally relates to synthetic compound eyes (CEs) useful in navigating unmanned aerial vehicles and more particularly, to a method of manufacturing a synthetic compound eye (CE).

### BACKGROUND OF THE INVENTION

Small rotary or flapping wing unmanned aerial vehicles (UAVs) have significant advantages over their fixed wing counterparts when the vehicle is required to hover or maneuver in, for example, building interiors, tunnels and caves. They must be extremely rugged to withstand harsh gust environments, endure obstacle collisions, operate in all types of weather, day and night, perform stationary hover and autonomously navigate in tightly constrained environments. Thus, these vehicles must be capable of performing highly maneuverable and hovering flight to avoid collisions with obstacles and to maneuver effectively in confined spaces. To achieve this autonomous performance, the micro-aerial vehicle must possess a navigational control capability, which possibly could be realized through incorporation of invertebrate vision processing and the CE. Insect vision, for example, represents a visual system wherein spatial, spectral, and polarization sensitivity and sensitive and reliable movement detection are incorporated and wherein neural coding strategies deal extremely effectively with contamination by noise. In addition, CEs in general consists of a set of micro-lenses located on non-planar surfaces such that each lens samples image space via angular discrimination. Each micro-lens is pointed in a different direction and hence a different angle. CEs with a different magnification, or combinations of different magnifications, are possible and would be highly relevant for use in micro-robotics and micro-unmanned aerial vehicles (micro-UAVs). In such cases the weight budget for the host vehicle is primarily delegated to the task of propulsion (and energy source) and navigation/flight control, sometimes through quite complex terrain. There is little of the vehicle weight budget available for visual/image processing of sensor acquired data via electronic computation. CEs by their very nature solve this problem by performing much of the processing optically. In recent years, exceptional progress has been made in understanding the visual strategies that invertebrates use to cope with navigation and flight control. Desirable are panoramic insect-like based vision systems that are useful in analyzing panoramic optic flow and in detecting, chasing, or evading targets. The research in these areas, together with advances in miniaturized power sources and new, high authority microactuators, will lead to UAVs with unprecedented capabilities.

Accordingly, there is a need in the prior art to provide a low cost method of manufacturing insect-like CEs that would not only be useful for unmanned aerial vehicles, but also in other areas where exact image processing is not necessary. The present invention addresses this need.

### SUMMARY OF THE INVENTION

One object of the present invention is to provide a low cost method of manufacturing a CE.

This and other objects of the invention are achieved by a manufacturing a CE by ablating a monolithic structure with a laser and then creating a mould from the monolithic structure and duplicating the mould. After one CE is constructed, then an inverse mask (mould) is created and the monolithic sphere, retaining its' registration, is covered in liquid plastic and placed into the mould and the exact replica is re-created. The advantage is low cost and rapid manufacture of the CE.

### BRIEF DESCRIPTION OF THE DRAWINGS

The foregoing and other objects, aspects and advantages will be better understood from the following detailed description of the invention with reference to the drawings, in which:

FIG. 1 is a cross section view of the laser ablation system necessary in the method of the invention.

FIG. 2 is a side view of the laser ablation system as it is forming the monolithic precursor to the mould of the invention.

FIG. 3 is a side view of FIG. 2 showing more of the CE being manufactured.

FIG. 4 is a side of the CE of the invention, including a view of how connections are made to imaging array and necessary electronics of the invention.

FIG. 5 shows the present invention as being used in a potential application.

FIG. 6 shows the present invention as being used in a potential application.

### DETAILED DESCRIPTION OF THE INVENTION

The invention is a 2 to 3 step manufacturing method for CEs. The first step, which is not necessary for duplication, uses laser ablation to form a CE.

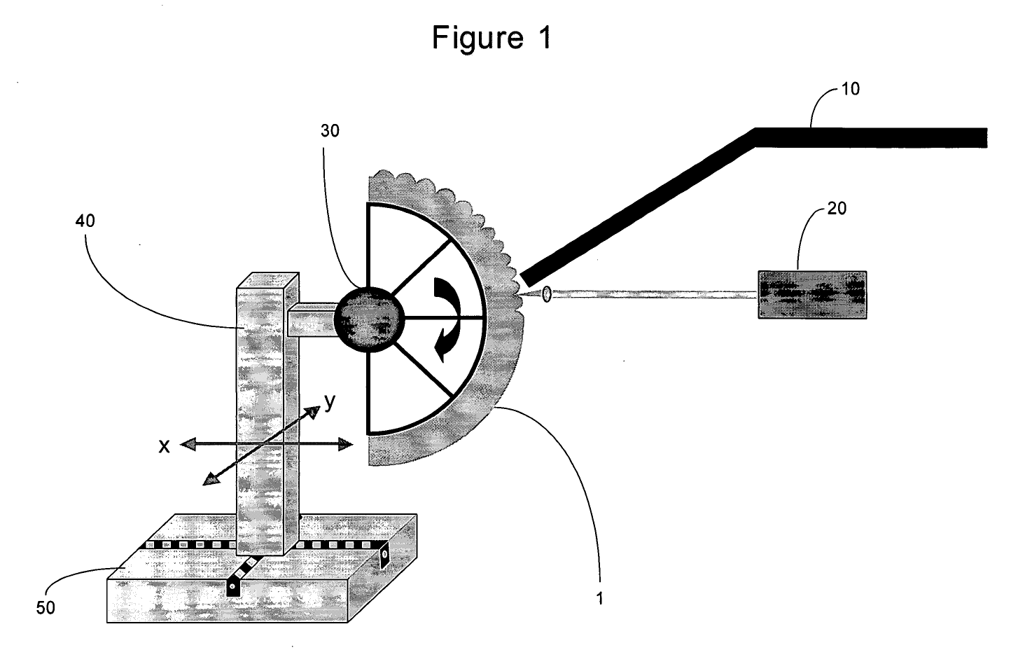

As shown in FIG. 1, a hemisphere of a monolithic material 1 is mounted on a two rotational axis ball 30. The rotational ball 30 is mounted on a two axis translational stage 50 and support 40. A UV Eximer Laser 20 is then used to ablate the surface of the monolithic material and “write out” the desired lens surfaces by moving the rotational ball 30 and the two axis translational stage 50 in tandem in a pre-programmed manner (shown by the arrows).

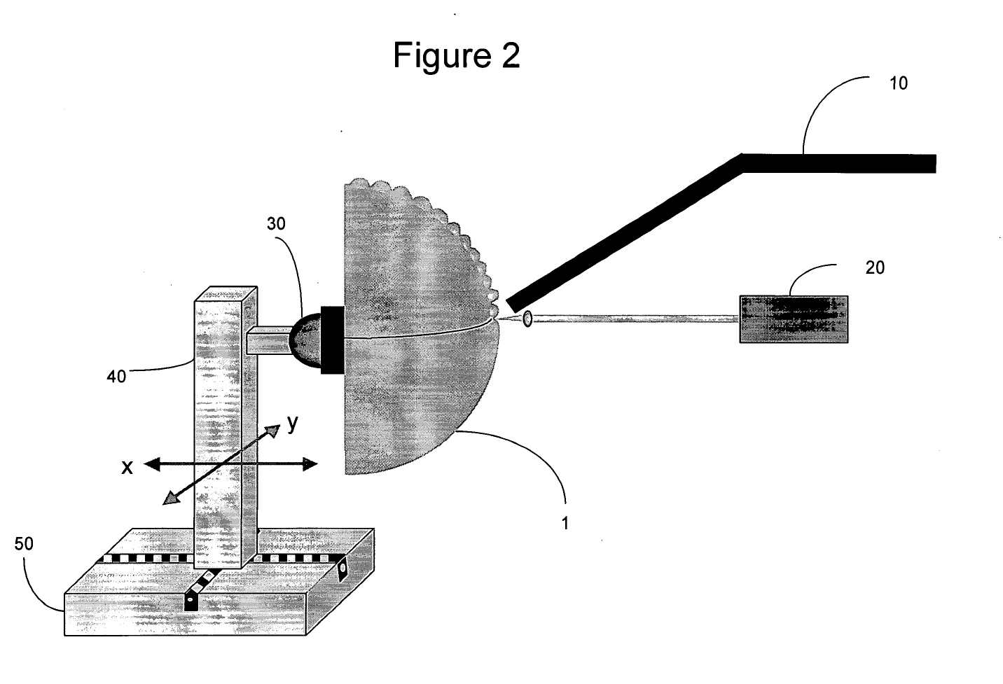

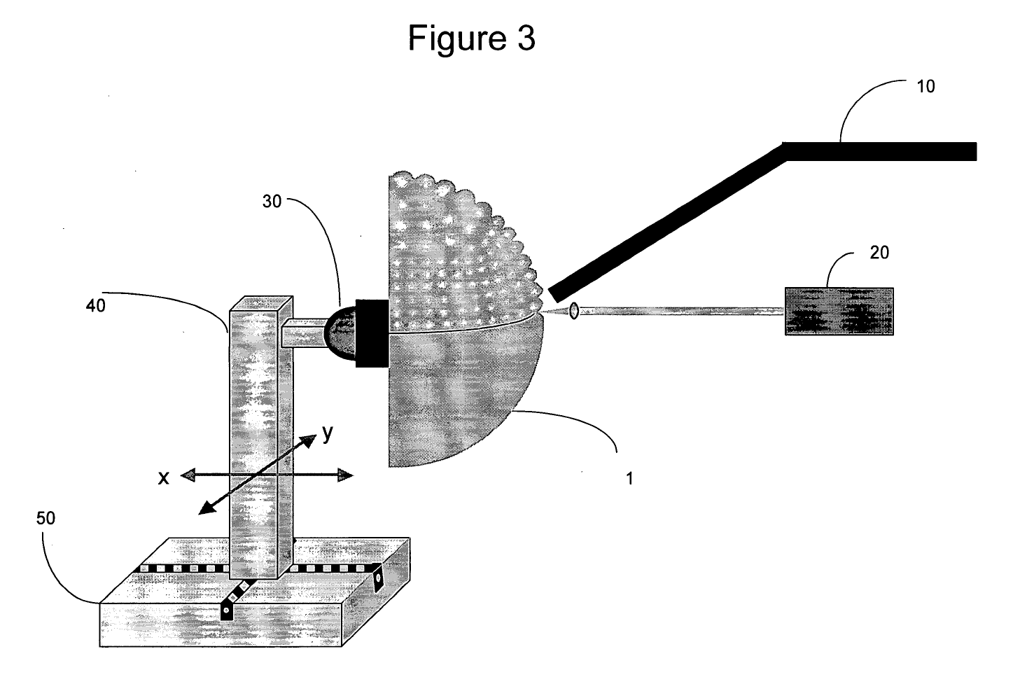

FIGS. 2 and 3 show how the lenslets would be formed over the entire hemisphere. Note that a vacuum 10 is used to clear debris away from the area during the ablation process. Obviously, the movement of the rotational ball 30 and the two axis translational stage 50 would have to be such that it would form the three dimensional structure necessary for producing the various lenslets. Those skilled in the art would be able to engineer this process give this disclosure.

A drawback to creating the CEs with only laser ablation is that it would be an expensive and a time consuming process because each lens would have to be separately ablated. Accordingly, the invention encompasses a second step to create a mould from the ablated monolithic structure and then produce other CEs from the mould.

For this second step, a CE is created by the process described above and then an inverse mask (mould) is created and the monolithic sphere, retaining its' registration, is covered in liquid plastic and placed into the mould and the exact replica is re-created.

The material composition and approximate dimensions of the CE would have the same range as with insects. That means that the size would range from a less than one millimeter to approximately five millimeters (5 mm).

As for the composition of the CE, optical glasses and plastics in the visible range of the spectrum to infrared (IR) transmitting materials such as ZnSe, ZnS, Quartz, CaF₂, etc., and UV transmitting materials in the UV, such as CaF₂, and others could all be used.

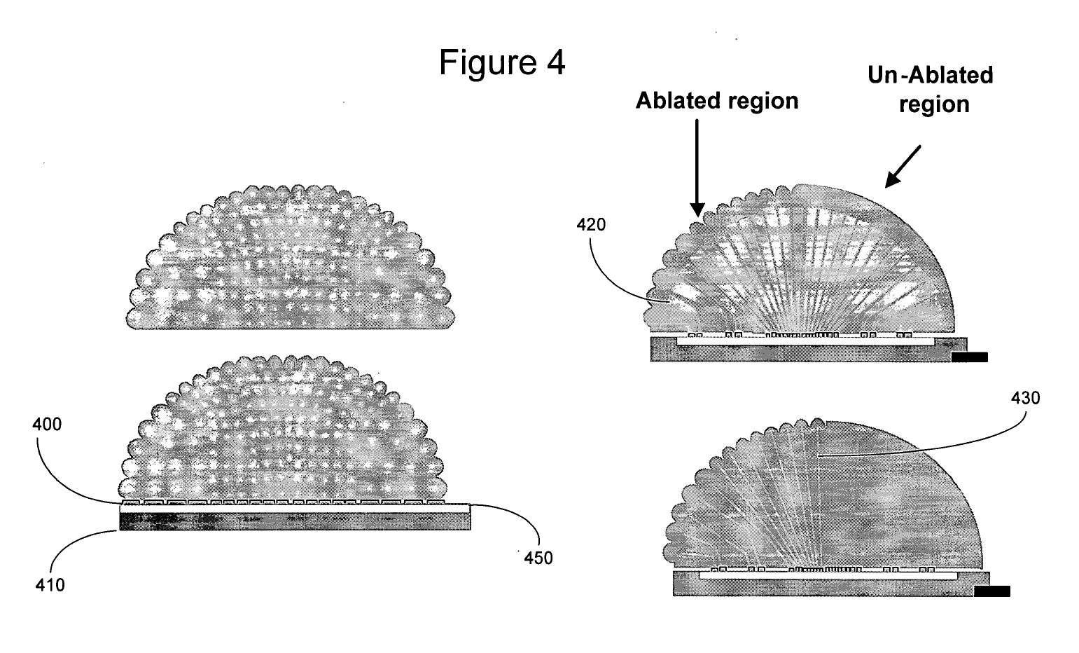

A third step in the method of the invention would then be to couple fiber optics to each of the CE lenslets. This is shown in FIG. 4. Basically, a fiber bundle 430 with the registration of the fiber input would be used to take the light from each CE lenslet element 420 to its' appropriate detector pixel 400 or pixel group (Note: Each fiber may bring the light down to a single pixel or an image down to a pixel group. In this later case if image formation is required the separate images are fused via electronic image processing). Hence, a one-to-one correlation between the optical bump (lenslet) and a corresponding detector element (pixel or pixel group) would be formed. This is bridged by the appropriate optical fiber element. As for the actual mounting of the molded monolithic structures, once the additional lenses are molded, they are replicated onto tapered fiber sub-elements 420/430. Then, the formed mold/fiber portion of the compound is mounted on the sensors and attached to a platform/substrate 450 and 410, respectively.

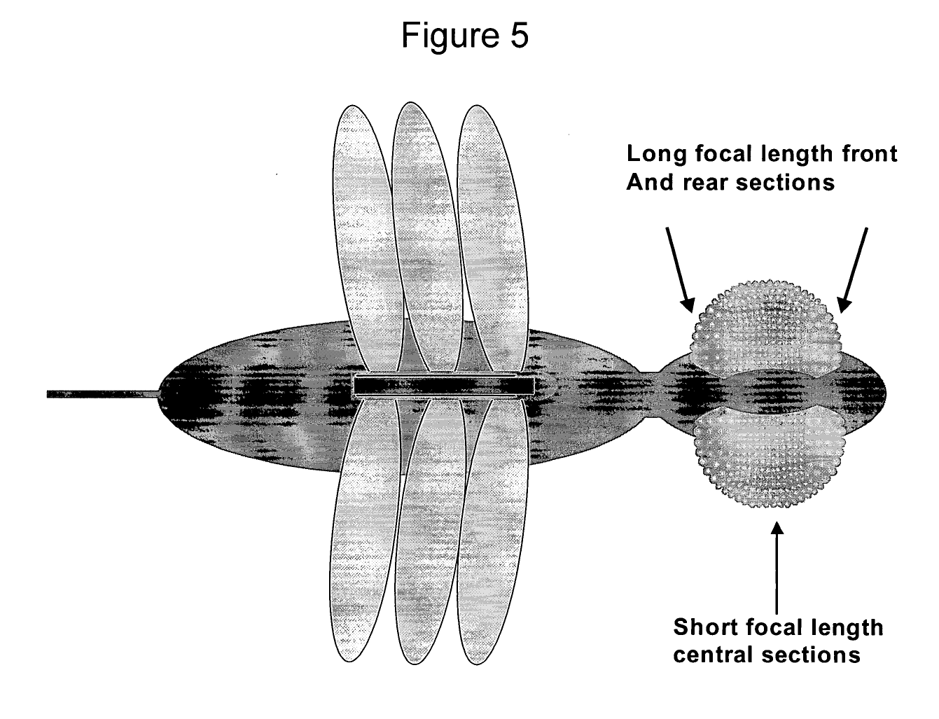

FIG. 5 shows a nominal use of the CE of the present invention.

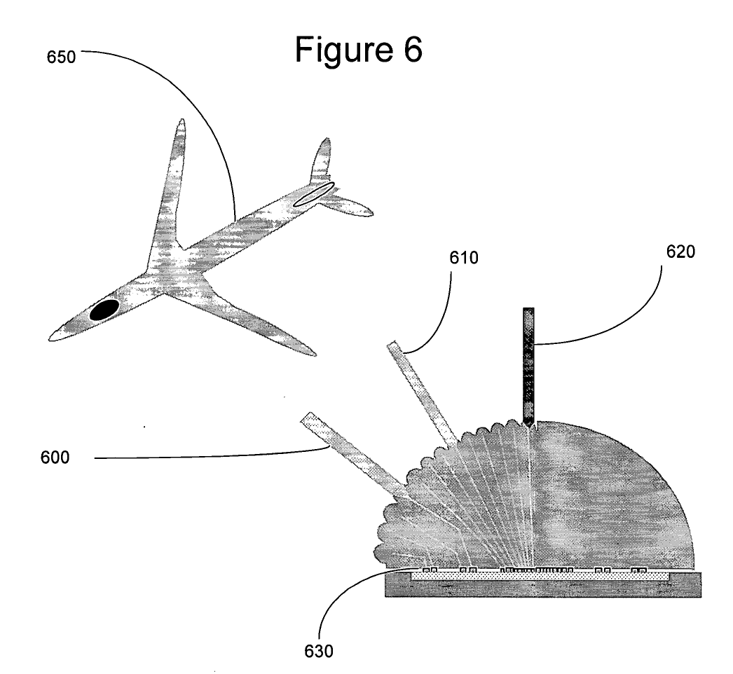

As shown in FIG. 6, each fiber 600, 610, and 620 etc. brings in the light that came from a specific angular portion of the field of view and would be received by pixel element 630. Angular velocity, therefore, is read directly based on the focal length and field of regard of each element. Data must still be processed, though, but the processing is very different than what it would be from a standard vertebrate type eye. For a CE, if the number of elements is large and the elements are all the same, the picture looks like a standard video image, with the exception that what was being mapped onto the image plane would not only carried amplitude information but also angular information, i.e. positional information is inferred. In a standard video picture, however, the image plane carries not only amplitude information but also positional information, i.e. angular information is inferred. Both cases are mosaics. The “grainy-ness” is determined by the pixel number, not by the whether the eye is compound or vertebrate/invertebrate. In other cases imaging is not required. For example, an insect may use angular information, such as vertical solar angle in the sky to determine time and coupled with its horizontal angular position, to navigate and build a “Look up table” reference matrix. That base table could be modified to account for the passage of time. A second “real time” travel matrix could then be created used comparatively with the reference matrix for navigating the return trip back to home base. In such case when the difference in the two matrices goes to a null matrix the insect would be home.

1. A method of manufacturing a compound eye comprising the steps of:
laser ablating a monolithic hemisphere of optic material to form a plurality of lenslets; and
attaching a means to display images from the plurality of lenslets.

2. The method of claim 1 further comprising the step of vacuuming away debris formed by the laser ablation process.

3. The method of claim 1 wherein the monolithic hemisphere of optic material is moved in relation to a laser ablation source via a rotational ball and a two axis translational stage moved in tandem in a pre-programmed manner.

4. The method of claim 3 further comprising the step of vacuuming away debris formed by the laser ablation process.

5. The method of claim 3 wherein the attaching a means to display images from the plurality of lenslets is accomplished by connecting one end of a fiber optic element to each lenslet and connecting the other end of the fiber optic element to a detector element thereby forming a one-to-one correlation between the lenslets and a corresponding detector.

6. The method of claim 5 wherein the fiber optic elements form a bundle of fibers.

7. The method of claim 5 wherein the fiber optic elements are molded in the monolithic hemisphere of optic material.

8. The method of claim 5 further comprising the step of vacuuming away debris formed by the laser ablation process.

9. The method of claim 7 wherein the monolithic hemisphere of optic material is attached to an array of detector elements.

10. A method of manufacturing a compound eye comprising the steps of:
laser ablating a monolithic hemisphere of optic material to form a plurality of lenslets;
forming an inverse mask duplicating the plurality of lenslets;
producing copies of the plurality of lenslets from the inverse mask; and
attaching a means to display images from the copies of the plurality of lenslets.

11. The method of claim 10 further comprising the step of vacuuming away debris formed by the laser ablation process.

12. The method of claim 10 wherein the monolithic hemisphere of optic material is moved in relation to a laser ablation source via a rotational ball and a two axis translational stage moved in tandem in a pre-programmed manner.

13. The method of claim 12 further comprising the step of vacuuming away debris formed by the laser ablation process.

14. The method of claim 10 wherein the attaching a means to display images from the copies of the plurality of lenslets is accomplished by connecting one end of a fiber optic element to each lenslet and connecting the other end of the fiber optic element to a detector element thereby forming a one-to-one correlation between the lenslets and a corresponding detector.

15. The method of claim 14 wherein the fiber optic elements form a bundle of fibers.

16. The method of claim 14 wherein the fiber optic elements are molded in the copies of the plurality of lenslets.

17. The method of claim 16 wherein each of the copies of the plurality of lenslets are attached to an array of detector elements.

18. The method of claim 1 wherein predetermined lenslets have the same focal length.

19. The method of claim 18 wherein lenslets with common focal length groups are grouped together for specific optical processing.

20. The method of claim 19 wherein there are a plurality of groups with different focal lengths arranged in uniquely defined patterns such that one compound eye can support a variety of separate processing, tracking, identification and analysis tasks.
